(19) United States
(12) Patent Application Publication
(10) Pub. No.: US 2013/0227602 A1
(43) Pub. Date: Aug. 29, 2013

(54) ELECTRONIC APPARATUS, CONTROL SYSTEM FOR ELECTRONIC APPARATUS, AND SERVER

(71) Applicant: Kabushiki Kaisha Toshiba, (US)

(72) Inventor: Shinichiro MANABE, Akishima-shi (JP)

(73) Assignee: KABUSHIKI KAISHA TOSHIBA, Tokyo (JP)

(21) Appl. No.: 13/711,472

(22) Filed: Dec. 11, 2012

(30) Foreign Application Priority Data
Feb. 23, 2012 (JP) 2012-037896

(51) Int. Cl. H04N 21/44

(52) U.S. Cl. CPC H04N 21/44008
USPC 725/19

(57) ABSTRACT

According to one embodiment, an electronic apparatus includes, a receiver configured to receive a stream, a memory configured to store the stream, an analyzer configured to analyze the stream to generate comparison data, an acquisition module configured to acquire object information indicative of an identity of an object, from a database, by using feature data corresponding to the comparison data, and a controller configured to control the memory so that the object information acquired by the acquisition module and the stream are stored in the memory.

### CROSS-REFERENCE TO RELATED APPLICATIONS

This application is based upon and claims the benefit of priority from prior Japanese Patent Application No. 2012-037896, filed Feb. 23, 2012, the entire contents of which are incorporated herein by reference.

### FIELD

Embodiments described herein relate generally to electronic apparatus, control system for electronic apparatus, and server.

### BACKGROUND

Conventionally, an electronic apparatus, such as a content playback apparatus, which can record and play back a content, such as a movie, a television program, and a game, has been widely used in general.

Electronic apparatus starts processing which acquires object information from a server using a video (image) or a sound according to an operation input by a user. For this reason, it may take time until object information is acquired after an operation input occurs.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an electronic apparatus according to an embodiment.

FIG. 2 is an exemplary view showing the electronic apparatus according to the embodiment.

FIG. 3 is an exemplary view showing the electronic apparatus according to the embodiment.

FIG. 4 is an exemplary view showing the electronic apparatus according to the embodiment.

FIG. 5 is an exemplary view showing the electronic apparatus according to the embodiment.

FIG. 6 is an exemplary view showing the electronic apparatus according to the embodiment.

### DETAILED DESCRIPTION

Various embodiments will be described hereinafter with reference to the accompanying drawings. In general, according to one embodiment, an electronic apparatus comprises, a receiver configured to receive a stream, a memory configured to store the stream, an analyzer configured to analyze the stream to generate comparison data, an acquisition module configured to acquire object information indicative of an identity of an object, from a database, by using feature data corresponding to the comparison data, and a controller configured to control the memory so that the object information acquired by the acquisition module and the stream are stored in the memory.

Hereinafter, an electronic apparatus, a control system for electronic apparatus, and a server according to an embodiment will be described in detail with reference to the drawings.

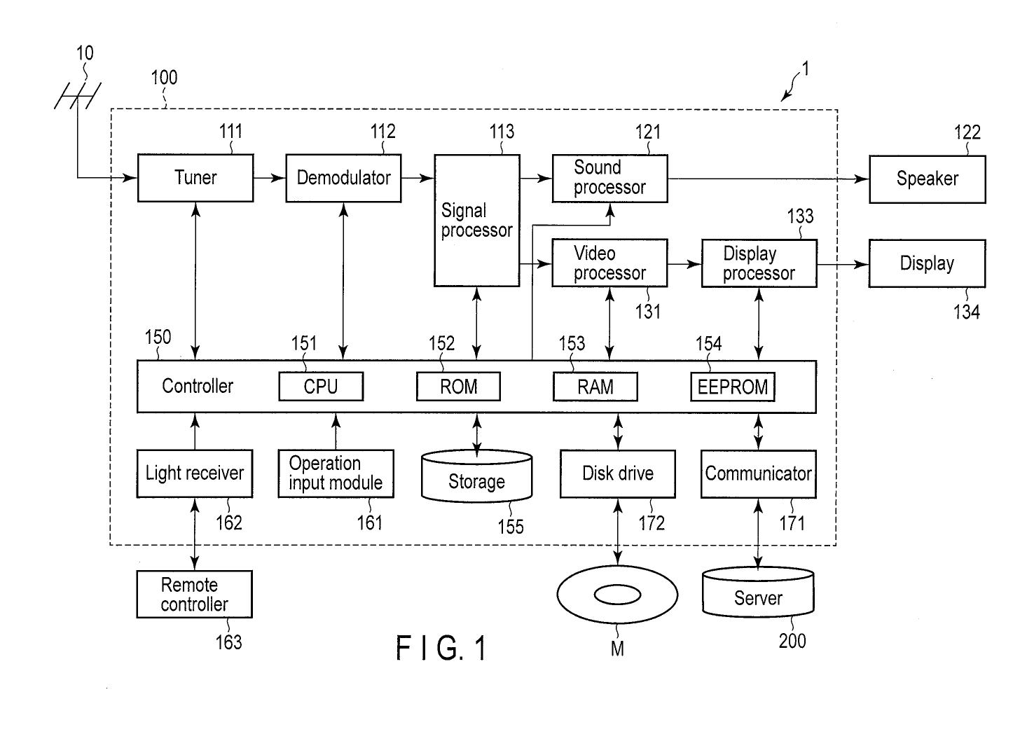

FIG. 1 illustrates an example of a system 1 including electronic apparatuses. For example, the system 1 includes a content recording and playback apparatus 100 and a server 200.

For example, the content recording and playback apparatus 100 is an electronic apparatus, such as a broadcasting receiver, which can record and play back a broadcasting signal or a content stored in a storage medium. Hereinafter, it is assumed that the content recording and playback apparatus 100 is a broadcasting receiver 100.

The broadcasting receiver 100 includes a tuner 111, a demodulator 112, a signal processor 113, a sound processor 121, a video processor 131, a display processor 133, a controller 150, a storage (memory) 155, an operation input module 161, a light receiver 162, a communicator 171, and a disk drive 172. The broadcasting receiver 100 may further include a speaker 122 and a display 134.

The tuner 111 is a tuner used for a digital broadcasting signal. For example, the tuner 111 can take a digital broadcasting signal received by an antenna 101. For example, the antenna 101 can receive a digital terrestrial broadcasting signal, a BS (broadcasting satellite) digital broadcasting signal, and/or a 110-degree CS (communication satellite) digital broadcasting signal.

The tuner 111 can take data of a broadcasting program content supplied from the digital broadcasting signal. The tuner 111 performs tuning (channel selection) of the digital broadcasting signal. The tuner 111 transmits the selected digital broadcasting signal to the demodulator 112.

The demodulator 112 demodulates the received digital broadcasting signal. Therefore, the demodulator 112 acquires content data, such as a transport stream (TS), from the digital broadcasting signal. The demodulator 112 inputs the acquired content data to the signal processor 113. That is, the tuner 111 and the demodulator 112 act as receiving means for receiving the content data.

The signal processor 113 performs signal processing, such as content data separation (multiple-separation). That is, the signal processor 113 separates the content data into a digital video signal (video picture), a digital sound signal (sound), and other pieces of data signal. The signal processor 113 supplies the sound signal to the sound processor 121. The signal processor 113 supplies the video signal to the video processor 131. The signal processor 113 supplies the pieces of data signal to the controller 150.

The signal processor 113 may be configured to supply the sound signal and the video signal to the controller 150. The signal processor 113 can convert the content data into recordable data (recording stream) under the control of the controller 150. The signal processor 113 can supply the recording stream to the storage 155, the disk drive 172, or another module under the control of the controller 150.

The sound processor 121 converts the digital sound signal received from the signal processor 113 into a signal (audio signal) having a format that can be played back by the speaker 122. For example, the sound processor 121 converts the digital sound signal into the audio signal through digital-analog conversion. The sound processor 121 outputs the audio signal. When the speaker 122 is connected to an output terminal of the sound processor 121, the sound processor 121 supplies the audio signal to the speaker 122. The speaker 122 plays back the sound based on the supplied audio signal.

The video processor 131 converts the digital video signal received from the signal processor 113 into a video signal having a format that can be played back by the display 134. That is, the video processor 131 decodes (plays back) the digital video signal received from the signal processor 113 into the video signal having the format that can be played back by the display 134. The video processor 131 outputs the video signal to the display processor 133.

For example, under the control of the controller 150, the display processor 133 performs image quality adjustment processing, such as a shade, brightness, sharpness, a contrast, or the others to the received video signal. The display processor 133 outputs the video signal to which the image quality adjustment is performed. When the display 134 is connected to an output terminal of the display processor 133, the display processor 133 supplies the video signal to which the image quality adjustment is performed to the display 134. The display 134 displays the video (video picture) based on the supplied video signal.

For example, the display 134 includes a liquid crystal display device. The liquid crystal display device includes a liquid crystal display panel that includes a plurality of pixels arrayed into a two-dimensional shape and a backlight that illuminates the liquid crystal display panel.

As described above, the broadcasting receiver 100 may be configured to include the speaker 122 and the display 134. Alternatively, the broadcasting receiver 100 may be configured to include an output terminal that outputs the video signal. Alternatively, instead of the speaker 122, the broadcasting receiver 100 may be configured to include an output terminal that outputs the audio signal. Alternatively, the broadcasting receiver 100 may be configured to include an output terminal that outputs the digital video signal and the digital sound signal.

The controller 150 acts as control means for controlling a behavior of each module of the broadcasting receiver 100. The controller 150 includes a CPU 151, a ROM 152, a RAM 153, and an EEPROM 154. The controller 150 performs various pieces of processing based on an operation signal supplied from the operation input module 161.

The CPU 151 includes an arithmetic element that performs various pieces of arithmetic processing. The CPU 151 implements various functions by executing a program stored in the ROM 152 or the EEPROM 154.

A program for controlling the broadcasting receiver 100 and a program for implementing various functions are stored in the ROM 152. The CPU 151 activates the program stored in the ROM 152 based on the operation signal supplied from the operation input module 161. Therefore, the controller 150 controls the behavior of each module.

The RAM 153 acts as a work memory of the CPU 151. That is, an arithmetic result of the CPU 151 and data read by the CPU 151 are stored in the RAM 153.

The EEPROM 154 is a nonvolatile memory in which various pieces of setting information and a program are stored.

The controller 150 generates information (metadata) on the content based on the data signal supplied from the signal processor 113. The controller 150 supplies the generated metadata to the storage 155. Therefore, the controller 150 can control the storage 155 such that the metadata and the recording stream are stored while related with each other.

The metadata is the information (metadata) on the content. The metadata is the information indicating an outline of the content. When the content is a broadcasting program supplied by the broadcasting signal, the metadata further includes information indicating broadcasting time and date of the content. For example, the metadata includes one of or a plurality of pieces of information, such as “broadcasting time and date” of the content, “channel,” “broadcasting program (content) name,” “category,” “author,” and other pieces of “detailed information.”

The controller 150 generates object information by performing analytical processing based on the sound signal and the video signal, which are supplied from the signal processor 113. The controller 150 adds the generated object information to the metadata.

The storage 155 includes a storage medium in which the content is stored. For example, the recording stream supplied from the signal processor 113 can be stored in the storage 155. The recording stream can also be stored in the storage 155 while related with various pieces of additional information (metadata).

For example, the operation input module 161 includes an operation key or a touch pad, which generates the operation signal in response to an operation input of a user. The operation input module 161 may be configured to take the operation signal from a keyboard, a mouse, or another input device that can generate the operation signal. The operation input module 161 supplies the operation signal to the controller 150.

The touch pad includes a device that generates positional information based on a capacitance sensor, a thermosensor, or another type. When the broadcasting receiver 100 includes the display 134, the operation input module 161 may be configured to include a touch panel integral with the display 134.

For example, the light receiver 162 includes a sensor that receives the operation signal from the remote controller 163. The light receiver 162 supplies the received signal to the controller 150. The controller 150 receives the signal supplied from the light receiver 162, and the controller 150 amplifies the received signal to perform A/D conversion, thereby decoding the original operation signal transmitted from the remote controller 163.

The remote controller 163 generates the operation signal based on the operation input of the user. The remote controller 163 transmits the generated operation signal to the light receiver 162 by infrared communication. The light receiver 162 and the remote controller 163 may be configured to transmit and receive the operation signal by other wireless communications, such as a radio wave.

The communicator 171 is an interface that conducts communication with another instrument on a network, such as the Internet, an intranet, and a home network. For example, the communicator 171 includes a LAN connector or a module that conducts communication by wireless LAN. For example, in the broadcasting receiver 100, the communicator 171 can acquire the content recorded in the instrument on the network, and the content can be played back. The broadcasting receiver 100 can output the content data to the instrument connected to the communicator 171.

For example, the disk drive 172 includes a drive to which a compact disk (CD), a digital versatile disk (DVD), a Blu-ray disk (BD) (registered trademark), and an optical disk M that can record and play back a moving-image content can be loaded. The disk drive 172 reads the content from the loaded optical disk M, and supplies the read content to the controller 150.

When the broadcasting signal is received to acquire the content, the controller 150 can acquire the metadata from the broadcasting signal. For example, the controller 150 acquires the metadata from the data signal multiplexed on the content. For example, the controller 150 also acquires the metadata from a packet in which the metadata is stored.

The packet in which the metadata is stored is supplied as the broadcasting signal to the broadcasting receiver 100. For example, the packet in which the metadata is stored is a packet displaying Electronic Program Guide (EPG) information. The broadcasting receiver 100 can perform timer recording based on the EPG information. In this case, the metadata is used to search the broadcasting program.

When the user inputs the video recording operation, the controller 150 stores “broadcasting time and date,” “channel,” “broadcasting program name,” “category,” and other pieces of “detailed information” as the metadata in the storage 155 together with the recording stream.

Sometimes together with the content, the metadata is stored in the storage medium (memory), such as the optical disk M. In such cases, the controller 150 can acquire the content and the metadata from the storage medium (memory).

In the broadcasting receiver 100, the communicator 171 can conduct communication with the server 200 on the network.

The server 200 includes a communicator, a storage, and a controller. The communicator conducts communication with another instrument on the network. A plurality of pieces of object information are stored in the storage (memory). The controller reads the object information from the storage, and controls the communication of the communicator.

The object information and feature data are stored in the storage of the server 200 while related with each other. That is, the storage of the server 200 acts as a database. For example, the object information indicates an identity of an object, such as a person, an animal, and an article. For example, the object information includes a name, a classification tag, detailed information, and related information of the object.

For example, when the object is the person, the detailed information includes pieces of information, such as a profile of the person. For example, when the object is the animal, the detailed information includes pieces of information, such as a kind of the animal. For example, when the object is the article, the detailed information includes pieces of information, such as a name, manufacturer, and usage of the article.

The related information includes news relating to the object and a link to a news site. For example, when the object is the article, such as a product, the related information includes a link to a site in which the product of the object can be purchased.

The feature data related with the object information includes pieces of information, such as a voice, a specific sound, or an image of the object. For example, when the object is the person, the feature data includes feature data generated from the voice of the person and feature data generated from a face image of the person. For example, when the object is the animal, the feature data includes feature data generated from a call of the animal and feature data generated from the image of the animal. For example, when the object is the article, the feature data includes feature data generated from the specific sound, such as an engine sound of the article, and feature data generated from the image of the article.

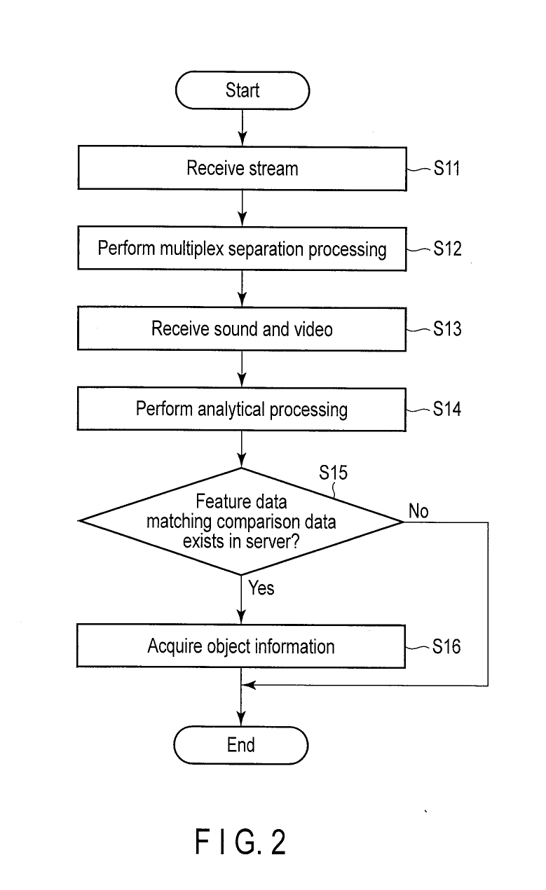

FIG. 2 illustrates an example of the behavior of the broadcasting receiver 100.

The signal processor 113 of the broadcasting receiver 100 receives the content (stream) (Step S11). The signal processor 113 performs the multiplex separation processing to the received stream (Step S12). Therefore, the signal processor 113 separates the stream into the sound signal, the video signal, and the data signal. When the video of the content is recorded, under the control of the controller 150, the signal processor 113 converts the stream of the content into the recording stream, and supplies the recording stream to the storage 155.

The controller 150 receives the sound signal and the video signal (Step S13). The controller 150 also receives the data signal. The controller 150 generates the metadata based on the received data signal.

The controller 150 analyzes the received sound signal and video signal (Step S14). The controller 150 generates comparison data by analyzing the sound signal and the video signal.

The controller 150 determines whether the feature data corresponding to the comparison data exists in the server 200 (Step S15). When the feature data corresponding to the comparison data exists in the server 200, the controller 150 acquires the object information, by using the feature data corresponding to the comparison data from the server 200 (Step S16). The controller 150 adds the object information to the metadata, and stores the metadata in the storage 155.

Through the processing in FIG. 2, the broadcasting receiver 100 can acquire the object information from the server in recording the video of the content, and store the video recording content while correlating the object information with the video recording content.

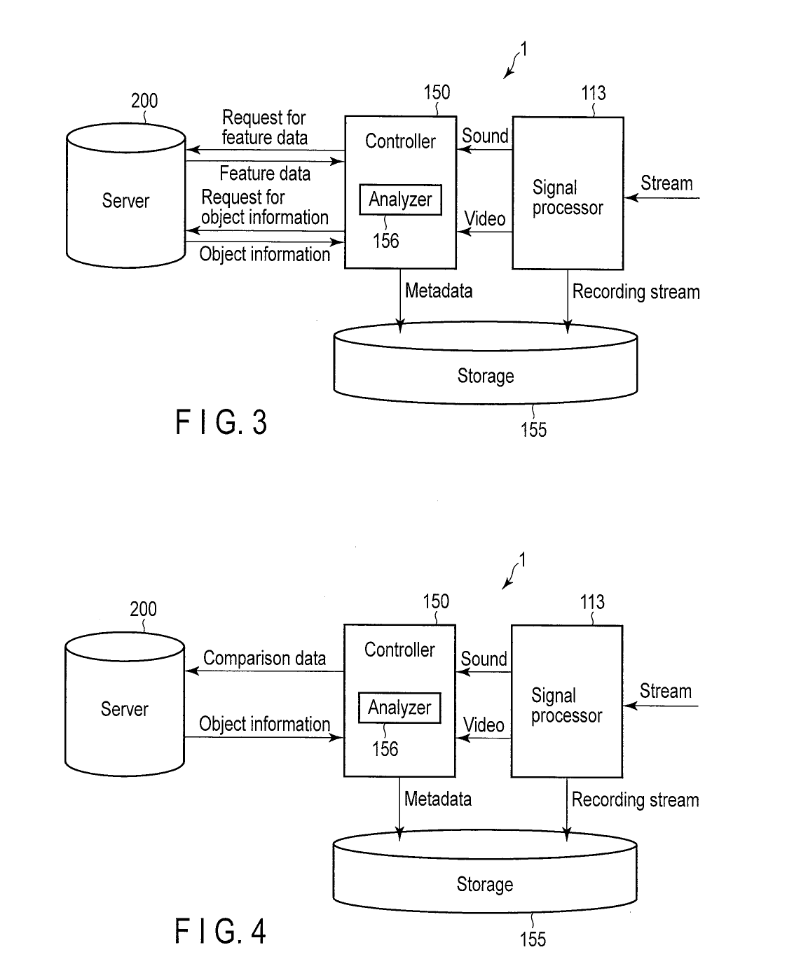

FIG. 3 illustrates an example of a specific behavior of the system 1 including the broadcasting receiver 100 and the server 200.

The controller 150 includes an analyzer 156. The controller 150 can construct the analyzer 156 by executing the program and the application, which are stored in the ROM 152 or the EEPROM 154.

As described above, the signal processor 113 separates the stream into the sound signal, the video signal, and the data signal when receiving the stream of the content. Under the control of the controller 150, the signal processor 113 converts the stream of the content into the recording stream, and supplies the recording stream to the storage 155.

The analyzer 156 of the controller 150 analyzes the sound signal and the video signal, which are supplied from the signal processor 113, and acquires the object information from the server 200 based on an analytical result. The controller 150 stores the generated object information in the storage 155 while adding the object information as the metadata to the recording stream.

First of all, a method by a sound analysis will be described.

The analyzer 156 analyzes the sound signal to generate a feature included in the sound signal. For example, when the sound signal is the voice, the analyzer 156 generates a waveform of a signal at each frequency as the feature from the voice. The analyzer 156 generates the comparison data using the generated feature. The generated feature may directly be used as the comparison data, or the generated feature in which a volume is decreased may be used as the comparison data.

For example, the analyzer 156 generates the comparison data by analyzing the waveform of the sound signal in each minimum unit (for example, PES (Packetized Elementary Stream)) constituting the sound signal.

The controller 150 makes a request of the server 200 for the feature data. When receiving the request for the feature data, the server 200 transmits the feature data related with the plurality of pieces of object information stored in the storage (memory) to the broadcasting receiver 100.

When receiving the feature data from the server 200, the controller 150 compares the comparison data generated by the analyzer to the received plurality of pieces of feature data. The controller 150 determines whether the comparison data matches the pieces of feature data.

With the feature data corresponding to the comparison data as an index, the controller 150 makes a request of the server 200 for the object information. That is, the controller 150 transmits the feature data corresponding to the comparison data to the server 200. When receiving the request for the object information, the server 200 reads the object information related with the received feature data from the storage (memory). The server 200 transmits the read object information to the broadcasting receiver 100.

The controller 150 adds the object information received from the server 200 to the metadata, and stores the metadata in the storage 155 together with the recording stream.

When the sound signal is the voice, the analyzer 156 may be configured to generate text data (character information) from the voice. In this case, the controller 150 can add the text data to the object information.

The controller 150 can also generate a keyword from the text data, and narrow down the feature data acquired from the server 200. In this case, the controller 150 adds the generated keyword to the request for the feature data, and transmits the request to the server 200. The server 200 narrows down the feature data based on the received keyword and a content of the object information. The server 200 transmits the narrowed-down feature data to the controller 150. Therefore, a volume of feature data compared to the comparison data can be reduced.

Next, a method by a video analysis will be described below.

The analyzer 156 analyzes the video signal to generate the object included in the video signal. For example, the analyzer 156 generates the object, such as the person, the animal, and the article, from a screen. Further, the analyzer 156 generates the comparison data using the image of the generated object. In this case, the object image may directly be used as the comparison data, or the object image in which the volume is decreased may be used as the comparison data.

For example, the analyzer 156 generates the comparison data by analyzing the video signal in each minimum unit (for example, frame) constituting the video signal.

The controller 150 makes the request of the server 200 for the feature data. When receiving the request for the feature data, the server 200 transmits the feature data related with the plurality of pieces of object information stored in the storage (memory) to the broadcasting receiver 100.

When receiving the feature data from the server 200, the controller 150 compares the comparison data generated by the analyzer to the received plurality of pieces of feature data. The controller 150 determines whether the comparison data matches the pieces of the feature data.

With the feature data corresponding to the comparison data as the index, the controller 150 makes the request of the server 200 for the object information. That is, the controller 150 transmits the feature data corresponding to the comparison data to the server 200. When receiving the request for the object information, the server 200 reads the object information related with the received feature data from the storage (memory). The server 200 transmits the read object information to the broadcasting receiver 100.

The controller 150 adds the object information received from the server 200 to the metadata, and stores the metadata in the storage 155 together with the recording stream.

Further, the analyzer 156 may be configured to analyze information (positional information) indicating a region where the object is generated. The analyzer 156 may also be configured to analyze information (temporal information) indicating a time, for which the object is shot, by comparing a plurality of frames of the video signal. The controller 150 can add the positional information and the temporal information to the object information.

Next, a method in which the sound analysis and the video analysis are concurrently used will be described below.

Using the object information obtained by the method by the sound analysis, the controller 150 can simplify the processing by the video analysis. That is, using the object information obtained from the server 200 by the sound analysis, the controller 150 narrows down a comparison target.

For example, the controller 150 acquires the object information from the server 200 through the processing by the sound analysis. The controller 150 generates the name, the classification tag, and the like as narrowing down information from the acquired object information.

When making the request of the server 200 for the feature data, the controller 150 adds the narrowing down information to the request. The server 200 narrows down the feature data based on the received narrowing down information and the contents of the stored plurality of pieces of object information. The server 200 transmits the narrowed-down feature data to the controller 150. The controller 150 compares the comparison data generated from the video to the received feature data. Therefore, the volume of feature data compared to the comparison data generated from the video can be reduced.

The controller 150 may be configured to narrow down the feature data for the video comparison using the keyword. In this case, the controller 150 adds the keyword to the request for the feature data. The server 200 narrows down the feature data based on the received keyword and the contents of the stored plurality of pieces of object information. The server 200 transmits the narrowed-down feature data to the controller 150. The controller 150 compares the comparison data generated from the video to the received feature data.

For the concurrent use of the sound analysis and the video analysis, it is necessary that the server 200 previously stores both the feature data (first feature data) generated from the sound and the feature data (second feature data) generated from the video in each piece of object information.

In the system of the embodiment, the broadcasting receiver 100 is configured to compare the feature data to the comparison data. The system is not limited to the embodiment. The server 200 may be configured to compare the feature data to the comparison data.

FIG. 4 illustrates another example of the system 1 including the broadcasting receiver 100 and the server 200. In this case, the controller 150 transmits the comparison data, which is obtained by the sound analysis or the video analysis, to the server 200.

The server 200 compares the received comparison data to the feature data related with the plurality of pieces of object information stored in the storage (memory). Therefore, the server 200 determines whether the comparison data matches the feature data.

The server 200 reads the object information, which is related with the feature data corresponding to the comparison data, from the storage (memory). The server 200 transmits the read object information to the broadcasting receiver 100.

The controller 150 adds the object information received from the server 200 to the metadata, and stores the metadata in the storage 155 together with the recording stream.

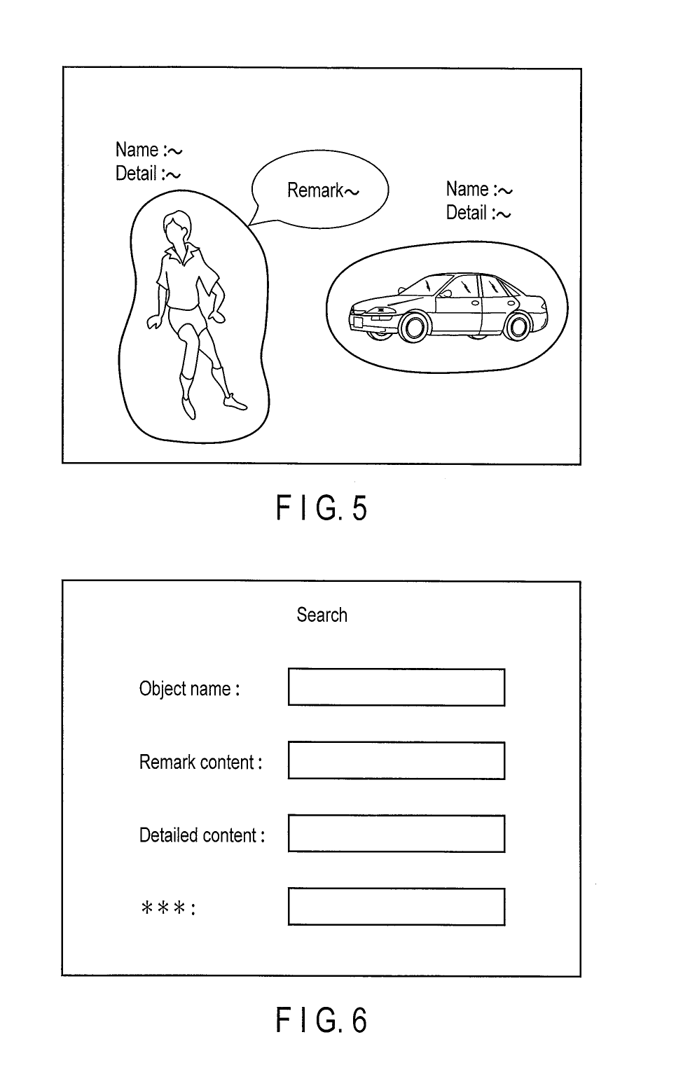

FIG. 5 illustrates an example of a method for using the metadata.

As described above, the controller 150 can play back the content stored in the storage 155, and the video processor 131 can generate the video. The controller 150 can superimpose the object information, which is related with the video recording content (recording stream), on the video by a function of on-screen display (OSD).

For example, when the video of the content recorded in the storage 155 is played back, the controller 150 of the broadcasting receiver 100 specifies the region where the object is shot in the video using the positional information of the object information of the metadata. Further, the controller 150 can display the object information (for example, the name and the detailed information) near the specified region. The controller 150 can also display the text data, which is generated by the sound analysis, as a balloon near the specified region.

FIG. 6 illustrates an example of a method for using the metadata. The controller 150 of the broadcasting receiver 100 can search a content including a specific object using the metadata, which is stored while related with the video recording content. That is, the controller 150 can search the recording stream while targeting at the object information, which is related with the recording stream stored in the storage 155.

For example, the controller 150 can check whether the target object (the person or the article) is included in the content. Using the temporal information of the object information, the controller 150 can play back only the time the target object is shot.

As described above, the broadcasting receiver 100 performs the sound analysis and the video analysis while storing the recording stream, which allows the broadcasting receiver 100 to sequentially generate the comparison data. The broadcasting receiver 100 can acquire the object information from the server 200 using the comparison data. Therefore, the broadcasting receiver 100 can store the recording stream while correlating the recording stream with the metadata including the object information.

In this case, it is not necessary to refer to the database in each search. Therefore, the broadcasting receiver 100 can perform high-speed search processing.

The broadcasting receiver 100 can simplify the processing of comparing the comparison data generated from the video to the feature data by the concurrent use of the sound analysis and the video analysis.

The broadcasting receiver 100 can generate the text data from the voice of the person, and add the generated text data as the object information to the metadata. The broadcasting receiver 100 can also narrow down the feature data used for the comparison to the generated text data. Therefore, the broadcasting receiver 100 can further enhance the processing speed.

As a result, the higher convenient electronic apparatus, control system for electronic apparatus, and server can be provided.

Note that, in the above-described embodiment, the broadcasting receiver 100 stores the recording stream and the metadata in the storage 155. However, the broadcasting receiver (electronic apparatus) 100 is not limited to the configuration. The broadcasting receiver 100 may be configured to store the recording stream and the metadata in not the storage 155 but the optical disk M, another instrument on the network, an instrument connected using a USB, a memory card, and another storage medium connected to the broadcasting receiver 100.

In the above-described embodiment, the server 200 is connected to the broadcasting receiver 100 through the network. However, the server 200 is not limited to the configuration. The server 200 may be provided in a local area of the broadcasting receiver 100.

Functions described in the above embodiment may be constituted not only with use of hardware but also with use of software, for example, by making a computer read a program which describes the functions. Alternatively, the functions each may be constituted by appropriately selecting either software or hardware.

While certain embodiments have been described, these embodiments have been presented by way of example only, and are not intended to limit the scope of the inventions. Indeed, the novel embodiments described herein may be, embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a receiver configured to receive a stream;
a memory configured to store the stream;
an analyzer configured to analyze the stream to generate comparison data;
an acquisition module configured to acquire object information indicative of an identity of an object, from a database, by using feature data corresponding to the comparison data; and
a controller configured to control the memory so that the object information acquired by the acquisition module and the stream are stored in the memory.

2. The electronic apparatus of claim 1, wherein the analyzer further comprises a sound analyzer configured to analyze a sound signal of the stream to generate the comparison data, and
the acquisition module is further configured to acquire from the database, the object information, by using the feature data corresponding to the comparison data generated by the sound analyzer.

3. The electronic apparatus of claim 1, wherein the analyzer further comprises a video analyzer configured to analyze a video signal of the stream to generate the comparison data, and
the acquisition module is further configured to acquire from the database, the object information, by using the feature data corresponding to the comparison data generated by the video analyzer.

4. The electronic apparatus of claim 1, wherein the analyzer further comprises,
a sound analyzer configured to analyze a sound signal of the stream to generate first comparison data, and a video analyzer configured to analyze a video signal of the stream to generate second comparison data,
the acquisition module is further configured to narrow down the feature data stored in the database using first object information that is acquired based on the first comparison data generated by the sound analyzer, and to specify first feature data that matches the second comparison data generated by the video analyzer, from the narrowed-down feature data, and to acquire second object information, by using the specified second feature data.

5. The electronic apparatus of claim 1, wherein the analyzer further comprises,
a character generation module configured to analyze a sound signal of the stream to generate a character information, and a video analyzer configured to analyze a video signal of the stream to generate the comparison data, and
wherein the acquisition module is further configured to narrow down the feature data stored in the database using the character information, to specify first feature data corresponding to the comparison data generated by the video analyzer, from the narrowed-down feature data, and to acquire the object information, by using the specified first feature data.

6. The electronic apparatus of claim 1, further comprising a video generator configured to play back the stream that is stored in the memory, and to generate a video,
wherein the video generator is further configured to display the object information, by using the stream, on the video.

7. The electronic apparatus of claim 6, wherein the analyzer further comprises a video analyzer configured to analyze a video signal of the stream to generate the comparison data, and to generate the comparison data of an object, positional information indicative of a region where the object is generated, and temporal information indicative of a time the object is generated,
wherein the controller is configured to add the positional information and the temporal information to the object information that is acquired by the acquisition module, and
wherein the video generator is configured to display the object information on the video based on the positional information and the temporal information.

8. The electronic apparatus of claim 6, further comprising a display configured to display the video generated by the video generator.

9. The electronic apparatus of claim 1, further comprising a search module configured to search the stream for the object information, by using the stream stored in the memory.

10. A control system for electronic apparatus comprising:
an electronic apparatus; and
a server, wherein the server comprises
a memory configured to store feature data and object information indicative of an identity of an object, and
the electronic apparatus comprises:
a receiver configured to receive a stream;
a memory configured to store the stream;
an analyzer configured to analyze the stream to generate comparison data;
an acquisition module configured to acquire the object information, from the server, by using the feature data corresponding to the comparison data; and
a controller configured to control the memory so that the object information acquired
by the acquisition module and the stream are stored in the memory.

11. A server comprising:
a memory configured to store feature data and object information indicative of an identity of an object;
a receiver configured to receive comparison data from an external apparatus;
an acquisition module configured to acquire from a memory, the object information, by using feature data corresponding to the comparison data; and
a transmitter configured to transmit the object information acquired by the acquisition module to the external apparatus.
